(19) United States
(12) Patent Application Publication
(10) Pub. No.: US 2024/0178453 A1
(43) Pub. Date: May 30, 2024

(54) LITHIUM-ION BATTERY

(71) Applicant: ZHUHAI COSMX BATTERY CO., LTD., Zhuhai (CN)

(72) Inventors: Panlong GUO, Zhuhai (CN); Lin CHU, Zhuhai (CN); Weiping CHEN, Zhuhai (CN); Suli LI, Zhuhai (CN); Changan ZENG, Zhuhai (CN)

(73) Assignee: ZHUHAI COSMX BATTERY CO., LTD., Zhuhai (CN)

(21) Appl. No.: 18/394,166

(22) Filed: Dec. 22, 2023

Related U.S. Application Data
(63) Continuation of application No. PCT/CN2022/134648, filed on Nov. 28, 2022.

(30) Foreign Application Priority Data
Nov. 29, 2021 (CN) 202111433508.7

(51) Int. Cl. H01M 10/0569; H01M 4/133; H01M 4/36; H01M 4/48; H01M 4/587; H01M 4/62; H01M 10/0525; H01M 10/0567; H01M 4/02

(52) U.S. Cl. CPC H01M 10/0569; H01M 4/133; H01M 4/364; H01M 4/483; H01M 4/587; H01M 4/622; H01M 10/0525; H01M 10/0567; H01M 2004/027; H01M 2300/0042

(57) ABSTRACT

Disclosed is a lithium-ion battery, where ethylene sulfate, fluoroethylene carbonate, and a carboxylate ester organic solvent are introduced into a non-aqueous electrolyte solution, and a relationship between a negative electrode binder content X in a negative electrode plate and a DTD content A, an FEC content B, and a carboxylate ester organic solvent content Yin the non-aqueous electrolyte solution is further adjusted to meet: 10≤A+B≤21, 0.02≤X/(A+B+Y)≤0.2, and 0.02≤X/Y≤0.25, and a conductivity of an electrolyte solution at a low temperature and a migration rate of lithium ions may be improved, so that a negative surface may form a stable and low-impedance SEI interface, thereby improving low-temperature charging performance and high-rate discharging performance of a battery. Moreover, a cycling expansion rate of the lithium-ion battery may be reduced.

### CROSS-REFERENCE TO RELATED APPLICATIONS

The present disclosure is a continuation of International Application No. PCT/CN2022/134648, filed on Nov. 28, 2022, which claims priority to Chinese Patent Application No. 202111433508.7, filed on Nov. 29, 2021. The disclosures of the aforementioned applications are hereby incorporated by reference in their entireties.

### TECHNICAL FIELD

The present disclosure pertains to the field of lithium-ion battery technologies, and specifically relates to a lithium-ion battery.

### BACKGROUND

In recent years, lithium-ion batteries with high energy density have been a hot topic in scientific and industrial research. Improving energy density of a lithium-ion battery may significantly improve performance of a terminal product, for example, an intelligent electronic product may obtain a higher endurance capability. Improving specific capacity per gram of a material is a major means to improve the energy density of a lithium-ion battery. A theoretical specific capacity of a silicon (Si) -based negative electrode material is as high as 4200 mAh/g, and its lithium intercalation and deintercalation platform is relatively suitable, making it an ideal high-capacity negative electrode material for a lithium-ion battery.

However, in a charging and discharging process, a volume expansion of Si may reach 300% or more, and internal stress generated by a violent volume change easily causes pulverization and peeling of a negative electrode, which affects performance of a battery.

### SUMMARY

It is found through research that an existing binder has poor matching with an electrolyte solution, and adhesive strength in the electrolyte solution decreases rapidly, resulting in poor adhesion between negative electrode materials (especially silicon-based negative electrode materials). In view of this, the present disclosure provides a lithium-ion battery, in which an electrolyte solution and a binder interact with each other, to improve a lithium-ion transfer rate between a negative electrode (especially a silicon negative electrode) and the electrolyte solution, and also improve an SEI (solid electrolyte interface) film on a surface of the negative electrode (especially the silicon negative electrode), thereby reducing an impedance of the lithium-ion battery, improving an interface status of the lithium-ion battery, and improving low-temperature charge performance and high-rate discharge performance of the lithium-ion battery. The binder and the electrolyte solution in the present disclosure are matched to enable an obtained lithium-ion battery to have a high energy density while implementing excellent low-temperature charge performance and high-rate discharge performance.

The present disclosure is intended to be implemented by using the following technical solutions.

A lithium-ion battery is provided, and the lithium-ion battery includes a positive electrode plate, a negative electrode plate, a separator, and a non-aqueous electrolyte solution. The negative electrode plate includes a negative electrode current collector and a negative electrode active material layer coated on a surface of either or both sides of the negative electrode current collector, and the negative electrode active material layer includes a negative electrode active material, a negative electrode conductive agent, and a negative electrode binder. The non-aqueous electrolyte solution includes ethylene sulfate (DTD), fluoroethylene carbonate (FEC), and a carboxylate organic solvent. The lithium-ion battery meets the following relationships:

10≤A+B≤21,

0.02≤X/(A+B+Y)≤0.2, and

0.02≤X/Y≤0.25,

where A is a mass percentage of the ethylene sulfate in the non-aqueous electrolyte solution, B is a mass percentage of the fluoroethylene carbonate in the non-aqueous electrolyte solution, Y is a mass percentage of the carboxylate organic solvent in the non-aqueous electrolyte solution, and X is a mass percentage of the negative electrode binder in the negative electrode active material layer.

A, B, X, and Y denote mass percentages, in a unit of wt %. When these parameters are used in a formula for calculation, only a numeric part (excluding unit) is taken. For example, when A is 5 wt % and B is 5 wt %, A +B =10, but not 0.1.

Preferably, 12≤A +B≤18. For example, A+B is 10, 11, 12, 13, 14, 15, 16, 17, 18, 19, 20, 21 or a value in a range formed by any two of the foregoing values.

Preferably, 0.05≤X/(A+B+Y)≤0.18. For example, X/(A+B+Y) is 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.2, or a value in a range formed by any two of the foregoing values.

Preferably, 0.05≤X/Y≤0.2. For example, X/Y is 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, or a value in a range formed by any two of the foregoing values.

In an embodiment, the mass percentage A of the ethylene sulfate in the non-aqueous electrolyte solution ranges from 0.1 wt % to 2.5 wt %, for example, is 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.2 wt %, 1.5 wt %, 1.8 wt %, 2 wt %, 2.2 wt % or 2.5 wt %.

In an embodiment, the mass percentage B of the fluoroethylene carbonate in the non-aqueous electrolyte solution ranges from 7.5 wt % to 20.9 wt %, for example, is 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 19.5 wt %, 20 wt %, 20.5 wt % or 20.9 wt %.

In an embodiment, the mass percentage Y of the carboxylate organic solvent in the non-aqueous electrolyte solution ranges from 0.5 wt % to 40 wt %, for example, is 1 wt %, 1.2 wt %, 1.5 wt %, 1.8 wt %, 2 wt %, 2.2 wt %, 2.5 wt %, 2.8 wt %, 3 wt %, 3.2 wt %, 3.5 wt %, 3.8 wt %, 4 wt %, 4.5 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 25 wt %, 30 wt %, 35 wt % or 40 wt %.

In an embodiment, when the contents of ethylene sulfate (DTD) and fluoroethylene carbonate (FEC) in the non-aqueous electrolyte solution meet 10≤A+B≤21, a lithium-ion battery can form a relatively stable SEI film with good conductivity. Specifically, the FEC in the non-aqueous electrolyte solution can be used to form a stable SEI film on a negative electrode surface, thereby ensuring stable charging and discharge performance of the lithium-ion battery, and DTD can be used to generate organic sulfonate with good ionic conductivity on the negative electrode surface, thereby reducing an interface impedance. When addition amounts of ethylene sulfate (DTD) and fluoroethylene carbonate (FEC) are not in the foregoing range (10≤A+B≤21), and when a sum of the DTD content and the FEC content is less than an optimal value (such as A +B <10), an SEI film is not completely constructed, side reactions of the interface are increased, a large amount of electrolyte solution is consumed, a solvent is easily reduced on a surface of an electrode plate, and problems such as lithium deposition and gas expansion may occur in a battery. Thus, a capacity retention rate is low and a cycling expansion rate is high during battery cycling. In addition, at a low temperature, lithium deposition is easily caused in the battery due to an incomplete SEI film, which deteriorates battery performance. When the sum of the DTD content and the FEC content is greater than the optimal value (A+B>21), the SEI film on the surface of the negative electrode plate is too thick, resulting in an increase in the battery impedance and obstruction of a lithium-ion transmission, which may lead to a lithium precipitation phenomenon in a later stage of battery cycling, thereby affecting the cycling performance and high-rate discharge performance of the battery.

In an embodiment, the carboxylate organic solvent has a relatively small viscosity, which can improve low-temperature charge performance and high-rate discharge performance of a lithium-ion battery. In particular, when the content X of the negative electrode binder and the content Y of the carboxylate organic solvent meet 0.02≤X/Y≤0.25, a bonding effect of the negative electrode binder is relatively good, and a swelling rate of the negative electrode binder is also relatively low, so that a swelling rate of the negative electrode (especially a silicon negative electrode) in a charging and discharging process can be greatly reduced. When the content X of the negative electrode binder and the content Y of the carboxylate organic solvent are not in the foregoing range (0.02≤X/Y≤0.25), for an obtained lithium-ion battery, impedance is large, a side reaction is large, swelling of the negative electrode binder is not in an appropriate range, and a better expansion effect cannot be obtained and a better binding force cannot be achieved.

In an embodiment, when a relationship between the four parameters meets 0.02≤X/(A+B+Y)≤0.2, the negative electrode binder helps stabilize an SEI film on the negative electrode surface, reduces an impedance of the negative electrode surface, so as to shorten a diffusion path of lithium ion, and improve low-temperature charge performance and high-rate discharge performance of a lithium-ion battery. That is, the lithium-ion battery according to the present disclosure has a high energy density while implementing excellent low-temperature charge performance and high-rate discharge performance.

In an embodiment, the carboxylate organic solvent is selected from at least one of ethyl propionate, propyl propionate, or propyl acetate.

In an embodiment, the non-aqueous electrolyte solution further includes a functional additive, and the functional additive is selected from one or more of the following compounds: 1,3-propanesulfonic acid lactone, 1,3-propylene sulfonolactone, vinylene carbonate, fluoroethylene carbonate, ethylene sulfate, lithium difluorophosphate, lithium bis(trifluoromethanesulphonyl)imide, or lithium bis(fluorosulfonyl)imide.

In an embodiment, the non-aqueous electrolyte solution further includes a carbonate, and the carbonate is, for example, a cyclic carbonate and/or a linear carbonate.

The cyclic carbonate is selected from at least one of ethylene carbonate or propylene carbonate. The linear carbonate is selected from at least one of dimethyl carbonate, diethyl carbonate, or ethyl methyl carbonate.

In an embodiment, the non-aqueous electrolyte solution further includes an electrolyte lithium salt.

According to the present disclosure, the electrolyte lithium salt is selected from at least one of lithium hexafluorophosphate and lithium perchlorate.

In an embodiment, a concentration of the electrolyte lithium salt in the non-aqueous electrolyte solution ranges from 0.5 mol/L to 2.0 mol/L.

In an embodiment, the negative electrode active material includes a silicon-based negative electrode material.

In an embodiment, the silicon-based negative electrode material is selected from at least one of elemental silicon, silicon monoxide, or silicon carbon.

In an embodiment, the negative electrode active material further includes a carbon-based negative electrode material.

In an embodiment, the carbon-based negative electrode material includes at least one of artificial graphite, natural graphite, mesocarbon microbead, hard carbon, or soft carbon.

In an embodiment, in the negative electrode active material, a mass ratio of the silicon-based negative electrode material to the carbon-based negative electrode material ranges from 10:0 to 1:9, for example, is 1:9, 2:8, 3:7, 4:6, 5:5, 6:4, 7:3, 8:2, 9:1 or 10:0. When the mass ratio of the silicon-based negative electrode material to the carbon-based negative electrode material is 10:0, it indicates that there is no carbon-based negative electrode material in the negative electrode active material.

In an embodiment, the negative electrode binder is selected from a polyanionic binder.

In an embodiment, the polyanionic binder includes a polymer, and a molecular chain of the polymer includes at least one or a combination of more of following groups:

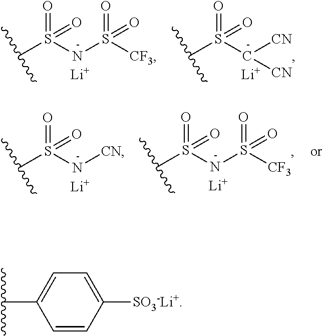

In an embodiment, a molar percentage of the group included in the polyanionic binder ranges from 5 mol % to 100 mol % , for example, is 5 mol % , 10 mol % , 20 mol % , 30 mol % , 40 mol % , 50 mol % , 60 mol % , 70 mol % , 80 mol % , 90 mol % , or 100 mol % . In the polyanionic binder including the foregoing group, when the molar percentage of the included group is greater than or equal to 5%, low-temperature charge performance and high-rate discharge performance of a battery may be improved. Specifically, a characteristic of this type of group is that there is a strong electron-withdrawing group or delocalized electron group around anions, which makes bonding energy between anions and cations weak. Lithium ions are less bound by an electrostatic action and are easy to migrate, and the lithium ions have higher conductivity, may participate in transmission of lithium ions, and can shorten a diffusion path of the lithium ions, thereby improving low-temperature charge performance and high-rate discharge performance of a battery.

In an embodiment, the molar percentage of the group included in the polyanionic binder preferably ranges from 10 mol % to 60 mol % .

In an embodiment, the polymer further includes a repeating unit structure formed by a flexible monomer, and the flexible monomer includes at least one of an acrylate, acrylonitrile, vinyl alcohol, or acrylic acid.

A molar percentage of the repeating unit structure formed by the flexible monomer included in the polyanionic binder ranges from 0 mol % to 95 mol % , for example, is 0 mol % , 5 mol % , 10 mol % , 20 mol % , 30 mol % , 40 mol % , 50 mol % , 60 mol % , 70 mol % , 80 mol % , 90 mol % , or 95 mol % .

In an embodiment, a molar percentage of the group included in the polyanionic binder ranges from 10 mol % to 80 mol % .

Flexibility of the polyanionic binder may be further improved by introducing a flexible monomer into the polyanionic binder for copolymerization, so that the polyanionic binder has high ionic conductivity, high elastic modulus, and elongation at break.

In an example, the polymer has a structure shown in Formula I,

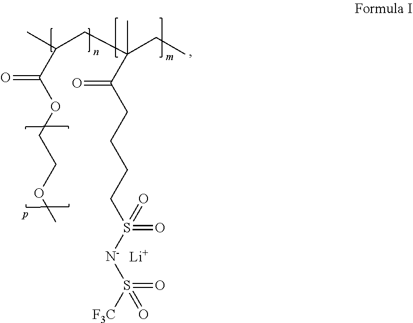

where m=10-200, preferably ranges from 20 to 120; n=0-190, preferably ranges from 20 to 16; and p=1-50, preferably ranges from 1 to 10.

In an embodiment, an ionic conductivity of the polyanionic binder ranges from 10⁻3 S/cm to 10⁻⁸ S/cm.

In an embodiment, an elastic modulus of the polyanionic binder ranges from 0.2 MPa to 1000 MPa.

In an embodiment, an elongation at break of the polyanionic binder ranges from 5% to 200%.

In an embodiment, the polyanionic binder has a high elastic modulus, so that thickness expansion of a silicon negative electrode may increase and decrease through an intermolecular force such as hydrogen bond and electrostatic like a spring when lithium ions are intercalated and deintercalated. That is, the polyanionic binder in the present disclosure may participate in transfer of lithium ions, and a diffusion path of the lithium ions can be shortened, thereby improving low-temperature charge performance and high-rate discharge performance of a lithium-ion battery.

In an embodiment, the mass percentage X of the negative electrode binder in the negative electrode active material layer ranges from 0.5 wt % to 15 wt %, for example, is 0.5 wt %, 0.6 wt %, 0.8 wt %, 1 wt %, 1.2 wt %, 1.5 wt %, 1.8 wt %, 2 wt %, 2.2 wt %, 2.5 wt %, 2.8 wt %, 3 wt %, 3.2 wt %, 3.5 wt %, 3.8 wt %, 4 wt %, 4.5 wt %, 5 wt %, 6 wt %, 7 wt %, 8 wt %, 9 wt %, 10 wt %, 11 wt %, 12 wt %, 13 wt %, 14 wt %, or 15 wt %.

In an embodiment, the negative electrode conductive agent is selected from at least one of conductive carbon black, acetylene black, Ketjen black, conductive graphite, conductive carbon fiber, carbon nanotube, metal powder, or carbon fiber.

In an embodiment, the mass percentage of the negative electrode conductive agent in the negative electrode active material layer ranges from 0.5 wt % to 15 wt %, for example, is 0.5 wt %, 0.6 wt %, 0.8 wt %, 1 wt %, 1.2 wt %, 1.5 wt %, 1.8 wt %, 2 wt %, 2.2 wt %, 2.5 wt %, 2.8 wt %, 3 wt %, 3.2 wt %, 3.5 wt %, 3.8 wt %, 4 wt %, 4.5 wt %, 5 wt %, 6 wt %, 7 wt %, 8 wt %, 9 wt %, 10 wt %, 11 wt %, 12 wt %, 13 wt %, 14 wt %, or 15 wt %.

In an embodiment, the positive electrode plate includes a positive electrode current collector and a positive electrode active material layer coated on a surface of either or both sides of the positive electrode current collector, and the positive electrode active material layer includes a positive electrode active material, a positive electrode conductive agent, and a positive electrode binder.

In an embodiment, the positive electrode conductive agent is selected from at least one of conductive carbon black, acetylene black, Ketjen black, conductive graphite, conductive carbon fiber, carbon nanotube, metal powder, or carbon fiber.

In an embodiment, the positive electrode binder is selected from at least one of sodium carboxymethyl cellulose, styrene-butadiene rubber, polytetrafluoroethylene, or polyethylene oxide.

In an embodiment, the positive electrode active material is selected from lithium cobalt oxide or lithium cobalt oxide doped and coated with one or more elements in Al, Mg, Ti, or Zr, and the lithium cobalt oxide doped and coated with one or more elements in Al, Mg, Ti, or Zr having a chemical formula of LiₓCo_{1-y1-y2-y3-y4}A_{y1}B_{y2}C_{y3}D_{y4}O₂, where 0.95≤x≤1.05, 0.01≤yl≤0.1, 0≤y2≤0.1, 0≤y3≤0.1, 0≤y4≤0.1, and A, B, C, and D are independently selected from one or more elements in Al, Mg, Ti, or Zr.

In an embodiment, a mass percentage of the positive electrode conductive agent in the positive electrode active material layer ranges from 0.5 wt % to 15 wt %.

In an embodiment, a mass percentage of the positive electrode binder in the positive electrode active material layer ranges from 0.5 wt % to 15 wt %.

In an embodiment, a mass percentage of the positive electrode active material in the positive electrode active material layer ranges from 70 wt % to 99 wt %.

In an embodiment, a main function of the separator is to separate a positive electrode plate and a negative electrode plate of a battery from each other, to prevent a short circuit caused by contact of two electrodes, and to allow ions in an electrolyte solution to pass through.

In an embodiment, a charging cut-off voltage of the lithium-ion battery is 4.48 V or more.

Terms and explanations are as follows.

In the present disclosure, the term “binder” refers to an adhesive in a lithium-ion battery, is an inactive component in an electrode plate of the lithium-ion battery, and one of important materials used to prepare an electrode plate of the lithium-ion battery. A main function of the binder is to connect an electrode active material, a conductive agent, and an electrode collector, so that the three have an overall connectivity, thereby reducing an impedance of electrode, and making an electrode plate have good mechanical and machinable performance, which meets a requirement of actual production.

Beneficial effects of the present disclosure are as follows:

The present disclosure provides a lithium-ion battery, in which an electrolyte solution and a binder interact with each other, to improve a lithium-ion transfer rate between a negative electrode (especially a silicon negative electrode) and the electrolyte solution, and also improve an SEI film on a surface of the negative electrode (especially the silicon negative electrode), thereby reducing an impedance of the lithium-ion battery, improving an interface status of the lithium-ion battery, and improving low-temperature charge performance and high-rate discharge performance of the lithium-ion battery. The binder and the electrolyte solution in the present disclosure are matched to enable an obtained lithium-ion battery to have a high energy density while implementing excellent low-temperature charge performance and high-rate discharge performance

Specifically, in the present disclosure, DTD, FEC, and a carboxylate organic solvent are introduced into a non-aqueous electrolyte solution, and a relationship between a negative electrode binder content X in a negative electrode plate and a DTD content A, an FEC content B, and a carboxylate organic solvent content Y in the non-aqueous electrolyte solution is further adjusted to meet: 10≤A+B≤21, 0.02≤X/(A+B+Y)≤0.2, and 0.02≤X/Y≤0.25, so that a stable and low impedance SEI interface may be formed on a surface of negative electrode, a conductivity of a non-aqueous electrolyte solution at a low temperature and a migration rate of lithium ions can be improved, and the low-temperature charge performance and high-rate discharge performance of the battery are further improved. Moreover, a cycling expansion rate of the lithium-ion battery can be reduced.

### BRIEF DESCRIPTION OF THE DRAWINGS

FIG. 1 is a nuclear magnetic spectrum diagram of a negative electrode binder A.

### DETAILED DESCRIPTION OF THE EMBODIMENTS

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

Experimental methods used in the following examples are conventional methods, unless otherwise specified. Reagents, materials, and the like used in the following examples are all commercially available, unless otherwise specified.

In the description of the present disclosure, it should be noted that the terms “first”, “second”, or the like, are only used for descriptive purposes, and do not indicate or imply relative importance.

### EXAMPLES AND COMPARATIVE EXAMPLES

Preparation of a negative electrode binder A:

A structure of the negative electrode binder A is shown below, and specific steps of a preparation process of the negative electrode binder A are as follows.

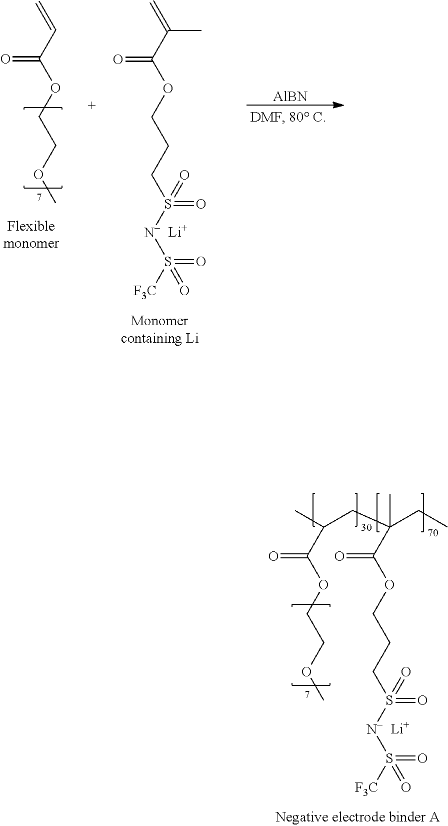

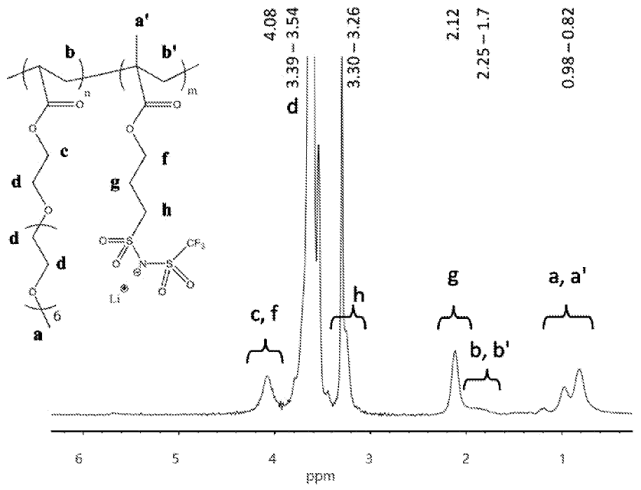

A monomer containing a lithium-ion and a flexible monomer (specific structure as described above) were dissolved in a DMF solvent at a molar ratio of 7:3, an initiator azobiisobutyronitrile with a molar ratio of 1% of a total monomer was added, and reacted at 80° C. for 10 hours in a vacuum state. The reacted solution was added to an acetone solvent to precipitate a reaction product, and the reaction product was filtered and dried for later use, to obtain the negative electrode binder A. The structure of the negative electrode binder A is confirmed by a nuclear magnetic spectrum diagram, as shown in FIG. 1.

### Preparation of a Positive Electrode Plate

A positive electrode active material lithium cobalt oxide (LCO), a binder polyvinylidene fluoride (PVDF), and a conductive agent acetylene black were mixed at a weight ratio of 97:1.5:1.5, and were added with N-methylpyrrolidone (NMP). The mixture was stirred under action of a vacuum mixer until a mixed system became a positive electrode slurry with uniform fluidity. The positive electrode slurry was evenly applied on a current collector aluminum foil. The coated aluminum foil was baked in an oven with five-stage different temperatures and then dried in an oven at 120° C. for 8 hours, followed by rolling and cutting, to obtain the required positive electrode plate.

### Preparation of a Negative Electrode Plate

A negative electrode active material (graphite and silicon monoxide with a mass ratio of 90:10), a thickener (sodium carboxymethyl cellulose (CMC-Na)), a binder (the negative electrode binder A prepared above), and a conductive agent (acetylene black) were mixed at a weight ratio of 98—X:1:X:1, and were added with deionized water. The mixture was stirred under action of a vacuum mixer to obtain a negative electrode slurry. The negative electrode slurry was evenly applied on carbon-coated copper foil with high strength to obtain a plate. The obtained plate were dried at room temperature and then transferred to an 80° C. oven for drying for 10 hours, followed by roller pressing and cutting, to obtain the negative electrode plate.

### Preparation of an Electrolyte Solution

In a glovebox filled with inert gas (argon) (H₂O<0.1 ppm, O₂<0.1 ppm), ethylene carbonate, propylene carbonate, diethyl carbonate, and propyl propionate (a mass ratio of ethylene carbonate, propylene carbonate, and diethyl carbonate is 1:1:1, and a content of propyl propionate (i.e., carboxylate) is shown in Table 1) were evenly mixed, and then 1.25 mol/L of fully dried lithium hexafluorophosphate (LiPF₆) was quickly added and dissolved in a non-aqueous organic solvent. The mixture was evenly stirred, and ethylene sulfate (DTD) and fluoroethylene carbonate (FEC) (contents of ethylene sulfate (DTD) and fluoroethylene carbonate (FEC) are shown in Table 1) were further added. The mixture was evenly stirred again, and a basic electrolyte solution was obtained after passing water content and free acid tests.

Preparation of a separator

A polyethylene separator with a coating layer having a thickness of 8μm was selected.

Preparation of a lithium-ion battery

The positive electrode plate, the separator, and the negative electrode plate prepared above were sequentially stacked to ensure that the separator was located between the positive electrode plate and the negative electrode plate for separation, and then winding was performed to obtain a bare cell without liquid injection. The bare cell was placed in outer packaging foil, the corresponding prepared electrolyte solution was injected into the dried bare cell, and after processes such as vacuum packaging, standing, forming, shaping, and sorting, a corresponding lithium-ion battery was obtained.

Low-temperature charging test of a lithium-ion battery

A voltage, an internal resistance, and a thickness T1 of a battery with 50% SOC obtained after OCV (Open-circuit voltage) testing were measured. Then, the battery was left standing for 4 hours in a constant temperature environment of 0° C., and a charge/discharge test was performed at a rate of 0.5C/0.5C, with a cut-off voltage ranging from 3.0 V to 4.48 V. After 50 cycles of charge/discharge, a cycling discharge capacity was recorded and divided by a discharge capacity of the first cycle to obtain a cycling capacity retention rate. After 50 cycles, the fully-charged battery was taken out of the 0° C. thermostat, a thickness T2 of the battery in a cold and fully-charged state after 50 cycles was immediately measured, and a thickness expansion ratio of the battery after 50 cycles was calculated, where Thickness expansion ratio (%)=(T2−T1)/T1×100%. In addition, the battery obtained after 50 cycles at a rate of 0.5C/0.5C and 0° C. was dissected, and a status of a negative electrode interface was observed and recorded. The test results are shown in Table 2.

Rate Discharging Test of a Lithium-Ion Battery

A battery with 50% SOC obtained after OCV testing was left standing for 10 minutes at room temperature, then discharged to 3.0 V at 0.5C, and left standing for 10 minutes. Then the battery was charged to 4.48 V at a constant current 0.5C with a constant voltage, left standing for 10 minutes, and then discharged to 3.0 V at different C-rates (such as 0.5C, 1C, 3C, 5C, or 10C). Discharge capacities at different discharging C-rates were recorded. A discharge capacity at 0.5C was used as a reference to calculate discharge capacity retention rates at different C-rates (relative to capacity at 0.5C). For specific performance data, see Table 3.

TABLE 1
Composition of lithium-ion batteries in Comparative Examples and Examples

| | Binder content | DTD content | FEC content | Carboxylate content | | X/(A + | |
|---|---|---|---|---|---|---|---|
| | X, % | A, % | B, % | Y, % | A + B | B + Y) | X/Y |
| Comparative | 0 | 0.5 | 10 | 30 | 10.5 | 0.000 | 0.000 |
| Example 1 | | | | | | | |
| Example 2 | 1 | 0.5 | 10 | 30 | 10.5 | 0.025 | 0.033 |
| Example 3 | 5 | 0.5 | 10 | 30 | 10.5 | 0.123 | 0.167 |
| Example 4 | 7 | 0.5 | 10 | 30 | 10.5 | 0.173 | 0.233 |
| Comparative | 10 | 0.5 | 10 | 30 | 10.5 | 0.247 | 0.333 |
| Example 5 | | | | | | | |
| Comparative | 15 | 0.5 | 10 | 30 | 10.5 | 0.370 | 0.500 |
| Example 6 | | | | | | | |
| Comparative | 20 | 0.5 | 10 | 30 | 10.5 | 0.494 | 0.667 |
| Example 7 | | | | | | | |
| Comparative | 3 | 0 | 10 | 30 | 10 | 0.075 | 0.100 |
| Example 8 | | | | | | | |
| Example 9 | 3 | 0.1 | 10 | 30 | 10.1 | 0.075 | 0.100 |
| Example 10 | 3 | 0.5 | 10 | 30 | 10.5 | 0.074 | 0.100 |
| Example 11 | 3 | 1 | 10 | 30 | 11 | 0.073 | 0.100 |
| Example 12 | 3 | 3 | 10 | 30 | 13 | 0.070 | 0.100 |
| Example 13 | 3 | 5 | 10 | 30 | 15 | 0.067 | 0.100 |
| Comparative | 3 | 0.5 | 0 | 30 | 0.5 | 0.098 | 0.100 |
| Example 14 | | | | | | | |
| Comparative | 3 | 0.5 | 1 | 30 | 1.5 | 0.095 | 0.100 |
| Example 15 | | | | | | | |
| Comparative | 3 | 0.5 | 5 | 30 | 5.5 | 0.085 | 0.100 |
| Example 16 | | | | | | | |
| Example 17 | 3 | 0.5 | 15 | 30 | 15.5 | 0.066 | 0.100 |
| Example 18 | 3 | 0.5 | 20 | 30 | 20.5 | 0.059 | 0.100 |
| Comparative | 3 | 0.5 | 30 | 30 | 30.5 | 0.050 | 0.100 |
| Example 19 | | | | | | | |
| Comparative | 3 | 0.5 | 10 | 0.1 | 10.5 | 0.283 | 30.000 |
| Example 20 | | | | | | | |
| Comparative | 3 | 0.5 | 10 | 10 | 10.5 | 0.146 | 0.300 |
| Example 21 | | | | | | | |
| Example 22 | 3 | 0.5 | 10 | 20 | 10.5 | 0.098 | 0.150 |
| Example 23 | 3 | 0.5 | 10 | 40 | 10.5 | 0.059 | 0.075 |
| Example 24 | 3 | 0.5 | 10 | 50 | 10.5 | 0.050 | 0.060 |

The binder content X refers to a mass percentage of a negative electrode binder in a negative electrode active material layer; a DTD content A refers to a mass percentage of DTD in a non-aqueous electrolyte solution; an FEC content B refers to a mass percentage of FEC in the non-aqueous electrolyte solution; and a carboxylate content Y refers to a mass percentage of the carboxylate in the non-aqueous electrolyte solution.

TABLE 2
Test results of low-temperature charge performance of lithium-
ion batteries in Comparative Examples and Examples

| | Low-temperature charge performance and negative lithium | | |
|---|---|---|---|
| | precipitation after 50 cycles at 0.5 C/0.5 C and 0° C. | | |
| | | Cycling | |
| | | capacity | Thickness |
| | Status of lithium precipitation at | retention | expansion |
| | negative electrode | rate | rate |
| Comparative | Detachment of coating, severe | 38.70% | 150.0% |
| Example 1 | lithium precipitation | | |
| Example 2 | No detachment of coating, no | 91.42% | 13.6% |
| | lithium precipitation | | |
| Example 3 | No detachment of coating, no | 94.89% | 4.6% |
| | lithium precipitation | | |
| Example 4 | No detachment of coating, no | 87.51% | 6.2% |
| | lithium precipitation | | |
| Comparative | No detachment of coating, lithium | 73.78% | 6.7% |
| Example 5 | precipitation | | |
| Comparative | No detachment of coating, serious | 65.83% | 7.9% |
| Example 6 | lithium precipitation | | |
| Comparative | No detachment of coating, serious | 47.67% | 94.5% |
| Example 7 | lithium precipitation | | |
| Comparative | No detachment of coating, lithium | 80.72% | 15.7% |
| Example 8 | precipitation | | |
| Example 9 | No detachment of coating, slight | 85.49% | 5.3% |
| | lithium precipitation | | |
| Example 10 | No detachment of coating, no | 97.84% | 4.5% |
| | lithium precipitation | | |
| Example 11 | No detachment of coating, no | 98.62% | 4.7% |
| | lithium precipitation | | |
| Example 12 | No detachment of coating, slight | 87.78% | 6.4% |
| | lithium precipitation | | |
| Example 13 | No detachment of coating, lithium | 84.48% | 7.1% |
| | precipitation | | |
| Comparative | No detachment of coating, serious | 55.82% | 20.2% |
| Example 14 | lithium precipitation | | |
| Comparative | No detachment of coating, serious | 60.78% | 18.7% |
| Example 15 | lithium precipitation | | |
| Comparative | No detachment of coating, serious | 73.46% | 16.3% |
| Example 16 | lithium precipitation | | |
| Example 17 | No detachment of coating, no | 98.31% | 4.2% |
| | lithium precipitation | | |
| Example 18 | No detachment of coating, no | 93.73% | 4.8% |
| | lithium precipitation | | |
| Comparative | No detachment of coating, serious | 78.14% | 8.9% |
| Example 19 | lithium precipitation | | |
| Comparative | No detachment of coating, serious | 77.68% | 11.8% |
| Example 20 | lithium precipitation | | |
| Comparative | No detachment of coating, lithium | 88.75% | 10.6% |
| Example 21 | precipitation | | |
| Example 22 | No detachment of coating, slight | 90.75% | 8.6% |
| | lithium precipitation | | |
| Example 23 | No detachment of coating, no | 95.88% | 7.9% |
| | lithium precipitation | | |
| Example 24 | No lithium precipitation, | 91.26% | 9.3% |
| | detachment of coating | | |

TABLE 3
Large-rate performance test results of lithium-ion
batteries in Comparative Examples and Examples

| | C-rate discharging status | | | | |
|---|---|---|---|---|---|
| | 0.5 C | 1 C | 3 C | 5 C | 10 C |
| Comparative | 100% | 83.95% | 71.62% | 42.59% | 5.00% |
| Example 1 | | | | | |
| Example 2 | 100% | 92.78% | 81.68% | 62.41% | 31.50% |
| Example 3 | 100% | 94.92% | 84.79% | 67.26% | 40.82% |
| Example 4 | 100% | 91.44% | 80.81% | 62.93% | 35.61% |
| Comparative | 100% | 89.16% | 77.37% | 59.04% | 30.72% |
| Example 5 | | | | | |
| Comparative | 100% | 87.67% | 74.82% | 55.84% | 26.34% |
| Example 6 | | | | | |
| Comparative | 100% | 84.34% | 71.15% | 51.59% | 20.48% |
| Example 7 | | | | | |
| Comparative | 100% | 89.86% | 77.48% | 58.93% | 30.51% |
| Example 8 | | | | | |
| Example 9 | 100% | 92.64% | 80.74% | 65.83% | 40.96% |
| Example 10 | 100% | 95.75% | 87.35% | 76.68% | 62.87% |
| Example 11 | 100% | 95.82% | 87.86% | 78.56% | 67.27% |
| Example 12 | 100% | 94.80% | 85.82% | 73.34% | 58.41% |
| Example 13 | 100% | 93.47% | 84.36% | 69.75% | 52.26% |
| Comparative | 100% | 86.43% | 70.49% | 48.51% | 16.05% |
| Example 14 | | | | | |
| Comparative | 100% | 87.23% | 74.15% | 54.65% | 25.11% |
| Example 15 | | | | | |
| Comparative | 100% | 90.48% | 80.39% | 66.14% | 41.37% |
| Example 16 | | | | | |
| Example 17 | 100% | 96.53% | 86.83% | 70.74% | 47.95% |
| Example 18 | 100% | 93.96% | 83.37% | 64.68% | 38.71% |
| Comparative | 100% | 90.84% | 77.89% | 57.93% | 28.15% |
| Example 19 | | | | | |
| Comparative | 100% | 94.29% | 83.26% | 63.78% | 36.34% |
| Example 20 | | | | | |
| Comparative | 100% | 94.87% | 84.53% | 66.36% | 40.49% |
| Example 21 | | | | | |
| Example 22 | 100% | 95.37% | 85.52% | 67.81% | 42.79% |
| Example 23 | 100% | 95.71% | 86.03% | 68.62% | 44.06% |
| Example 24 | 100% | 92.23% | 82.37% | 64.60% | 39.22% |

In Table 1, batteries in Comparative Example 1, Examples 2-4, and Comparative Examples 5-7 form a comparative battery group, in which a DTD content is 0.5%, an FEC content is 10%, and a carboxylate organic solvent content is 30%. In a case that only a content of the negative electrode binder A is changed, impact of the negative electrode binder A on battery performance is investigated.

When the content of the negative electrode binder A gradually increases, X/(A+B+Y) and X/Y also exhibit an increasing trend, where values of X/(A+B+Y) and X/Y for Comparative Example 1, Comparative Example 5, Comparative Example 6, and Comparative Example 7 are not in ranges of 0.02≤X/(A+B+Y)≤0.2, and 0.02≤X/Y <0.25 described above. It is shown from results of the cycling capacity retention rate and the thickness expansion rate in Table 2 that, with a gradual increase of the content of the negative electrode binder A, the cycling capacity retention rate and the thickness expansion rate of the lithium-ion batteries at 0° C. increase first and then decrease. In Table 3, high-rate discharge performance of the lithium-ion batteries shows a same trend. This indicates that an amount of the negative electrode binder in an appropriate range enables the negative electrode plate to be bonded well, and the negative electrode binder has a specific effect on constructing a stable SEI interface in an optimal state. In this case, a battery exhibits excellent performance Once the amount of the negative electrode binder is out of the range, due to an increase of a battery impedance, a side reaction on a surface of the negative electrode plate increases correspondingly, performance of the battery deteriorates, and a thickness expansion ratio increases to some extent, thereby affecting a lithium-ion diffusion path, and further affecting low-temperature charge performance and high-rate discharge performance of the battery.

In Table 1, batteries in Comparative Example 8, Examples 9-13, Comparative Examples 14-16, Examples 17 and 18, and Comparative Example 19 form a comparative battery group, in which a content of the negative electrode binder A is 3%, and a content of the carboxylate organic solvent is 30%. In a case that the FEC content and DTD content are changed, impact of FEC content and DTD content on battery performance is investigated.

When the DTD content and the FEC content gradually increase, results of the cycling capacity retention rate and the thickness expansion rate in Table 2 show that as the DTD content and the FEC content gradually increase, the cycling capacity retention rate of the batteries increases first and then decreases, and the thickness expansion rate decreases first and then increases. This indicates that FEC can be used to establish a relatively complete and stable SEI interface on a silicon-based negative electrode surface, and DTD can be used to generate organic sulfonate with good ionic conductivity on the negative electrode surface, thereby reducing an interface impedance. In addition, when a function of combination of FEC and DTD meets 10≤A+B≤21, a battery can form a relatively stable and good SEI interface, and battery performance is also relatively good. When the sum of DTD content and FEC content is less than the optimal value, an SEI interface is not completely constructed, side reactions of the interface are increased, and a large amount of electrolyte solution is consumed. A solvent is easily reduced on a surface of an electrode plate, and problems such as lithium deposition and gas expansion may occur in a battery. Thus, the capacity retention rate is low and the thickness expansion rate is high during battery cycling. In addition, at a low temperature, lithium deposition is easily caused in the battery due to an incomplete SEI film, which deteriorates battery performance. When the sum of DTD content and FEC content is greater than the optimal value, the SEI film on the surface of the negative electrode plate is too thick, resulting in an increase of the battery impedance and obstruction of a lithium ion transmission, which may lead to a lithium precipitation phenomenon in a later stage of battery cycling, thereby affecting low-temperature charge performance and high-rate discharge performance of the battery.

In Table 1, batteries in Comparative Examples 20 and 21, and Examples 22-24 form a comparative battery group, in which a content of the negative electrode binder A is 3%, a DTD content is 0.5%, and an FEC content is 10%. In a case that a content of the carboxylate organic solvent is changed, impact of the content of the carboxylate organic solvent on battery performance is investigated.

When the content of the carboxylate organic solvent gradually increases, values of X/(A+B+Y) and X/Y present a decreasing trend. It is shown from results of low-temperature disassembly interface status, the cycling capacity retention rate, and the thickness expansion rate in Table 2 that, with a gradual increase of the content of the carboxylate organic solvent, the cycling capacity retention rate and the thickness expansion rate of the lithium-ion batteries increase first and then decrease, and interfaces of the batteries also show a trend of gradual improvement. The high-rate discharge capacity retention rates in Table 3 also tends to increase first and then decrease. This is because the carboxylate organic solvent has a relatively small viscosity, so that a relatively high ion migration rate can be maintained at a low temperature, thereby improving low-temperature charge performance and high-rate discharge performance of a battery. In the meantime, the negative electrode binder and the carboxylate organic solvent also interact with each other. When the carboxylate organic solvent is relatively fewer, the negative electrode binder has a relatively smaller swelling rate and a relatively smaller toughness in an electrolyte solution, a silicon negative electrode has a relatively large thickness expansion rate in a charging and discharging process, and thus a function of the negative electrode binder cannot be well applied. The content of the carboxylate organic solvent is in an appropriate use range, and swelling of the negative electrode binder in the electrolyte solution reaches an appropriate degree. In this case, the toughness of the negative electrode binder is the largest, and the thickness expansion rate of the silicon negative electrode in a charging/discharging process is large, the negative electrode binder can function as a spring, and an electrode plate in the battery is bonded well. In addition, an appropriate amount of contents of FEC and DTD enables the battery to form an SEI interface with a stable low impedance. Therefore, performance of the battery is better, and a thickness expansion rate is within a normal range. However, when the content of the carboxylate organic solvent is too high, the swelling of the negative electrode binder is too high, which affects the function of the negative electrode binder.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

Wwhat is claimed is:

1. A lithium-ion battery, wherein the lithium-ion battery comprises a positive electrode plate, a negative electrode plate, a separator, and a non-aqueous electrolyte solution; the negative electrode plate comprises a negative electrode current collector and a negative electrode active material layer coated on a surface of either or both sides of the negative electrode current collector, and the negative electrode active material layer comprises a negative electrode active material, a negative electrode conductive agent, and a negative electrode binder; the non-aqueous electrolyte solution comprises ethylene sulfate, fluoroethylene carbonate, and a carboxylate organic solvent;
and the lithium-ion battery meets the following relationships:
10 <A+B <21, 0.02 <X/(A+B+Y) <0.2, and 0.02 <X/Y <0.25, wherein A is a mass percentage of the ethylene sulfate in the non-aqueous electrolyte solution, B is a mass percentage of the fluoroethylene carbonate in the non-aqueous electrolyte solution, Y is a mass percentage of the carboxylate organic solvent in the non-aqueous electrolyte solution, and X is a mass percentage of the negative electrode binder in the negative electrode active material layer.

2. The lithium-ion battery according to claim 1, wherein 12 <A+B <18.

3. The lithium-ion battery according to claim 1, wherein 0.05 <X/(A+B+Y) <0.18.

4. The lithium-ion battery according to claim 1, wherein 0.05 <X/Y <0.2.

5. The lithium-ion battery according to claim 1, wherein the mass percentage A of the ethylene sulfate in the non-aqueous electrolyte solution ranges from 0.1 wt % to 2.5 wt %.

6. The lithium-ion battery according to claim 1, wherein the mass percentage B of the fluoroethylene carbonate in the non-aqueous electrolyte solution ranges from 7.5 wt % to 20.9 wt %.

7. The lithium-ion battery according to claim 1, wherein the mass percentage Y of the carboxylate organic solvent in the non-aqueous electrolyte solution ranges from 0.5 wt % to 40 wt %.

8. The lithium-ion battery according to claim 1, wherein the mass percentage X of the negative electrode binder in the negative electrode active material layer ranges from 0.5 wt % to 15 wt %.

9. The lithium-ion battery according to claim 1, wherein the carboxylate organic solvent is selected from at least one of ethyl propionate, propyl propionate, or propyl acetate.

10. The lithium-ion battery according to claim 1, wherein the negative electrode active material comprises a silicon-based negative electrode material, and the silicon-based negative electrode material is selected from at least one of elemental silicon or silicon monoxide.

11. The lithium-ion battery according to claim 10, wherein the negative electrode active material further comprises a carbon-based negative electrode material, and the carbon-based negative electrode material comprises at least one of artificial graphite, natural graphite, mesocarbon microbead, hard carbon, or soft carbon.

12. The lithium-ion battery according to claim 1, wherein the negative electrode binder comprises a polyanionic binder, the polyanionic binder comprises a polymer, and a molecular chain of the polymer comprises at least one or a combination of more of following groups:

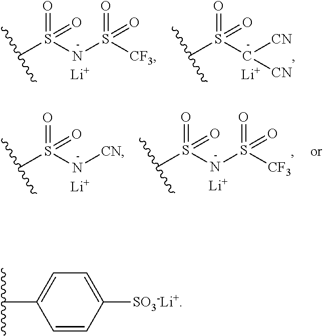

13. The lithium-ion battery according to claim 12, wherein a molar percentage of the group comprised in the polyanionic binder ranges from 5 mol % to 100 mol % .

14. The lithium-ion battery according to claim 13, wherein a molar percentage of the group comprised in the polyanionic binder ranges from 10 mol % to 60 mol % .

15. The lithium-ion battery according to claim 12, wherein the polymer further comprises a repeating unit structure formed by a flexible monomer, and the flexible monomer comprises at least one of an acrylate, acrylonitrile, vinyl alcohol, or acrylic acid.

16. The lithium-ion battery according to claim 15, wherein a molar percentage of the repeating unit structure formed by the flexible monomer comprised in the polyanionic binder ranges from 0 mol % to 95 mol % .

17. The lithium-ion battery according to claim 16, wherein a molar percentage of the repeating unit structure formed by the flexible monomer comprised in the polyanionic binder ranges from 10 mol % to 80 mol % .

18. The lithium-ion battery according to claim 15, wherein the polymer has a structure shown in Formula I, 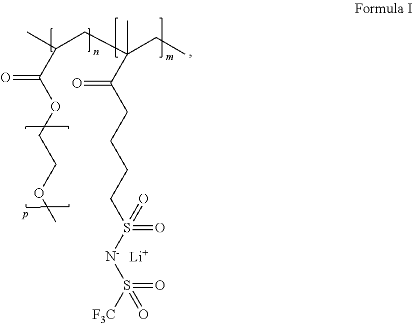
wherein m=10-200, preferably ranges from 20 to 120; n=0-190, preferably ranges from 20 to 160; and p=1-50, preferably ranges from 1 to 10.

19. The lithium-ion battery according to claim 18, wherein the polymer has a structure shown in Formula I, 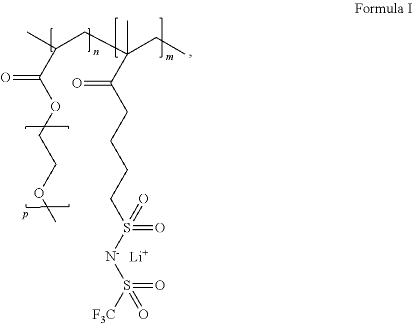
wherein m=20-120; n=20-160; and p=1-10.

20. The lithium-ion battery according to claim 11, wherein in the negative electrode active material, a mass ratio of the silicon-based negative electrode material to the carbon-based negative electrode material ranges from 10:0 to 1:9.
